(19) United States
(12) Patent Application Publication
(10) Pub. No.: US 2017/0319420 A1
(43) Pub. Date: Nov. 9, 2017

(54) PRESSURE CUFF DETECTION AND INFLATION SYSTEM

(71) Applicant: GRIFFITHS & NIELSEN LIMITED, WEST SUSSEX (UK)

(72) Inventor: CHRISTOPHER JOHN SAGGERS, BEDFORDSHIRE (GB)

(21) Appl. No.: 15/525,657

(22) PCT Filed: Nov. 10, 2015
(86) PCT No.: PCT/GB2015/053405

§ 371 Date: May 10, 2017

(30) Foreign Application Priority Data
Nov. 10, 2014 (GB) 1419968.1

(51) Int. Cl. A61H 1/00; A61H 9/00

(52) U.S. Cl. CPC A61H 1/008; A61H 9/0092; A61H 2205/12; A61H 2205/106; A61H 2201/5071; A61H 2201/1685; A61H 2201/1238; A61H 2201/0107; A61H 2209/00; A61H 2201/5007

(57) ABSTRACT

A pressure cuff detection system comprising an air compressor in communication with a pressurised air distributor having a plurality of pressurised air outlets, one or more of said outlets being in pressurised air communication with one type of pressure cuff selected from a group of possible such cuffs, each pressurised air outlet coupled to its own valve means adapted to open and close the outlets, control means provided to monitor, in use, pressure variation at said ports and thereby determine which ports are open and which are closed, and to identify from such determination the particular type of cuff actually connected to the port(s).

This invention relates generally to pressure cuffs, more specifically, this invention relates to a pressure cuff combined detection and inflation system useful in treatment of venous disease like deep vein thrombosis (DVT), Lymphedema and venous ulcers.

DVT arises from the development of blood clots in a vein and is also known as venous thrombosis. The condition can occur in the larger veins in the body, usually in the limbs and commonly in the legs. DVT is treated through; the prescription of anticoagulant medicines or Rivarixoban which prevent blood clots from forming easily, invasive inferior vena cava (IVC) filters, or other non-invasive and non-medicinal treatments.

Non-invasive and non-medicinal such treatments include exercise, raising the affected limb or pressure cuffs.

Pressure cuffs are worn around the affected area and when in use they apply pressure all around the limb thereby restricting the blood vessels and increasing blood pressure in that area. This increased blood pressure is advantageous as it promotes the better movement of blood. Some inactive pressure cuffs rely on their elasticity to compress the area and other active pressure cuffs rely on fluid pressure inside the cuff and a compressor to maintain that pressure. It is on this type of active pressure cuff that this invention is focused.

There are a range of different cuffs required for a varying range of treatment needs, for instance and only as an example, cuffs could include a foot cuff, a short calf cuff, a long calf cuff or a whole leg cuff, as well as cuffs designed for use on any other part of the body. Cuffs can also have one or more inflation chambers, for example a single chamber foot cuff, a single chamber calf cuff and a three chamber calf cuff.

This variety of cuff sizes and designs require a variety of air pressure ratings as each cuff has a different volume and pressure requirement. In order to accommodate this in the past, a different compressor for each type of cuff has been required, or it is necessary manually to select which type of cuff is attached to the compressor unit.

There are adverse implications if this manual identification, selection and coupling to the compressor unit is not performed correctly. If the pressure input is too low, the cuff will not be effective and the treatment could fail, or if the pressure input is too high, the cuff will be too tight around the users limb and will cause too high a pressure in the blood vessels.

The problems with having independent compressor units for each cuff to be inflated for the required therapy include needing much more apparatus to manage, the units are also more expensive to the health care provider and the patient.

It is therefore an aim of the present invention to provide an easy to use multi-cuff but single compressor cuff inflation system which is responsive to correctly inflate the types of cuff deployed without requiring input from an operator.

According to this invention there is provided a pressure cuff detection system comprising an air compressor in communication with a pressurised air distributor having a plurality of pressurised air outlets, one or more of said outlets being in pressurised air communication with one type of pressure cuff selected from a group of possible such cuffs, each pressurised air outlet coupled to its own valve means adapted to open and close the outlets, control means provided to monitor, in use, pressure variation at said ports and thereby determine which ports are open and which are closed, and to identify from such determination the particular type of cuff actually connected to the port(s).

The system is preferably a combined cuff type detection and inflation system, wherein detection setup and then inflation cycles can operate sequentially.

In an optional embodiment there is provided a pressure cuff detection system according to the embodiment above wherein the group of cuffs is a group of three, namely a three chamber calf cuff, a one chamber calf cuff and a one chamber foot cuff.

In another non-exclusive embodiment there is provided a pressure cuff detection system according to either one of the embodiments above wherein the system includes a pressure transducer for monitoring pressure between the compressor and the distributor.

In another further optional embodiment there is provided a pressure cuff detection system according to any one of or any combination of embodiments above wherein the pressure variation to be monitored is the pressure rise time.

In yet another further optional embodiment there is provided a pressure cuff detection system according to the embodiments above wherein secondary control means are provided for setting pressure and time cycles for the identified type of cuff.

There is also provided a method of detecting the presence of a particular type of cuff from amongst a group of possible types of cuff which involves use of a system as described in any one or any combination of the embodiments above.

In order that the invention may be illustrated, more easily appreciated and readily carried into effect by those skilled in this art, specific embodiments of the invention will now be described purely by way of non-limiting example only with reference to the accompanying drawings in which:

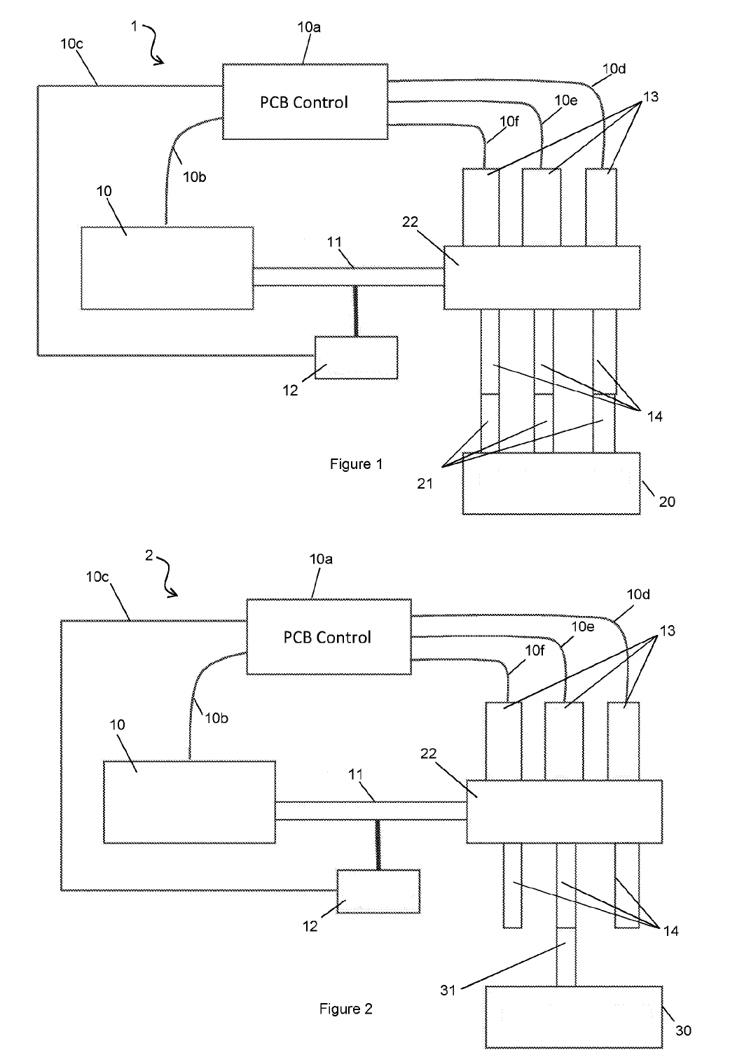

FIG. 1 is a simplified schematic of an embodiment of the system according to the present invention in communication with a three chamber DVT calf cuff;

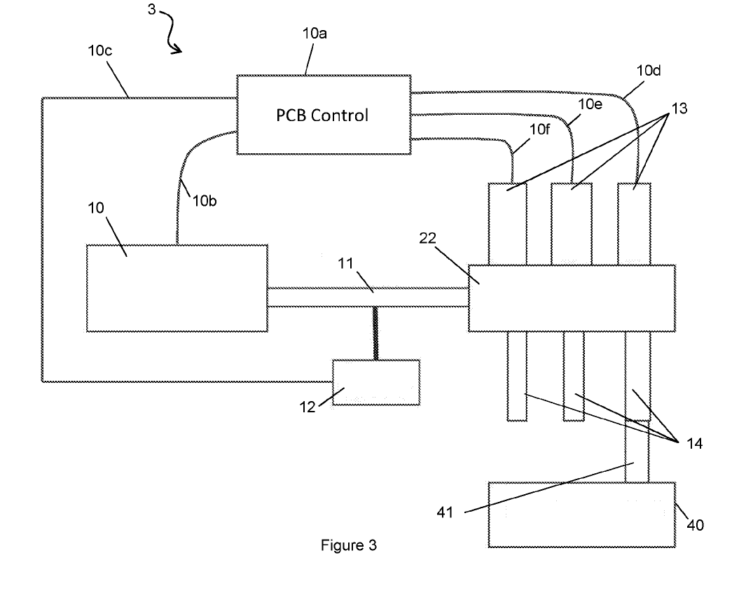

FIG. 2 is a simplified schematic of an embodiment of the system according to the present invention in communication with a one chamber DVT calf cuff; and

FIG. 3 is a simplified schematic of an embodiment of the system according to the present invention in communication with a one chamber DVT foot cuff.

FIGS. 1 to 3 demonstrate the system according to the embodiments of this invention each Figure showing the system connected to a different type of pressure cuff. Each Figure shows the system (1) including a compressor (10), an air supply hose (11), a pressure transducer (12), solenoid operated air valves (13) for controlling the air flow, and air outlets (14) to pressure cuffs (20, 30, 40).

A printed circuit board (PCB) control means 10A is connected to the compressor (10) via line (10B) and to the pressure transducer through line (10C) and to the solenoids (13) via lines 10D, E and F respectively.

FIG. 1 demonstrates the system (1) in communication with a pressure cuff in the form of a three chamber DVT calf cuff (20) and three air inlets (21) to the pressure cuff. This Figure demonstrates that all three air outlets are in use; this is registered by the system in initial setup mode which recognises the type of pressure cuff employed and can then switch to inflation mode and apply the correct inflation cycle times.

FIG. 2 demonstrates the system (1) in communication with a pressure cuff in the form of a one chamber DVT calf cuff (30) and one air inlet (31) to the pressure cuff. In this Figure the first and third air outlets (14) are blocked; this is registered by the system in initial setup mode which recognises the type of pressure cuff employed, and is adapted to operate the correct inflation pressures and cycle times according to the recognised cuff type.

FIG. 3 demonstrates the system (1) in communication with a pressure cuff in the form of a one chamber DVT foot cuff (40) having one air inlet (41) into the pressure cuff. In this Figure the first and second air outlets are blocked; this is registered by the system in initial setup mode which recognises the type of pressure cuff that has been connected.

### System Setup

The essential components to make a functioning system are an air compressor which has its outlet connected to an air manifold which supplies six air solenoids with an air supply. A pressure transducer is fed from the air manifold to monitor system pressure. The air outlets from the solenoid valves are then connected to a pair of three outlet connectors. A three up air tube plugs into this and connects the plug on the pressure cuff. The Control PCB is used to control the compressor, air solenoid valves and also monitor the system air pressure.

Three different types of cuff are used, a single chamber foot, a single chamber calf and a three chamber calf.

In the FIG. 1 arrangement all three air outlets (14) from the pressurised air distributor (22) are used to couple to the three chamber (20) cuff via the three air inlets (21) to that cuff. A standard connecting plug (not shown) can be used to effect the connection, which is 3-way or 3-port and all such ports in use here. In the arrangements illustrated in each of FIGS. 2 and 3, it is possible to use the same 3-way or 3-port connector (not shown) as with FIG. 1, but two of the ports (not in use) need to be blocked. The use of such standard connector plugs but with differently blocked ports enables in setup mode a pressure sensing device of the control means to sense which type of pressure cuff is attached to the pressurised air distributor.

### Operation

Initially the user plugs in a pair of cuffs to the pump box using the interconnecting air tubes. When the pump unit is switched on the system runs a setup mode. This sequentially turns on each solenoid valve and the compressor. The pressure transducer monitors the rate of pressure rise and then concludes which type of cuff is attached.

It manages this as different ports on the cuff are plugged and blocked. E.g. channel one is blocked for a foot cuff and channel two is blocked for a single chamber calf cuff. No channels are blocked for the three chamber cuff.

### Auto Detection

When the channel one solenoid is opened and the compressor turned on, if a foot cuff is attached the pressure would increase from 0 mmHg to 30 mmHg within less than a second. The control PCB monitors and times how long this sequence takes. If less than one second is achieved then if selects the foot cuff cycle. If more than one second then is goes onto the next stage of system setup.

When the channel one solenoid is opened and the compressor turned on, if a single chamber calf cuff is attached the pressure would increase from 0 mmHg to 30 mmHg in about 8 seconds. After 2 seconds the next channel is tested. As the second channel is block in the cuff air connector plug the pressure would increase from 0 mmHg to 30 mmHg within less than a second. The PCB would thus select the single chamber calf cycle.

Finally if the second channel takes over 2 seconds then the system is set to three chamber calf mode.

Each of the types of cuffs requires a different time cycle and inflation pressure.

Once the Control PCB has detected which cuffs are connected the system parameters are set for each of the pair of outlets and there is no human intervention, or error.

### Benefits

By the use of this Auto cuff detection system the human error of selecting the incorrect cuff is eliminated. This means that staff training is also massively reduced and the associated risk to the patient of receiving an incorrect treatment has hugely reduced.

A medical devices are now heavily risk assessed and removal of any human factors plays a key role.

1-7. (canceled)

8. A pressure cuff detection system comprising an air compressor in communication with a pressurised air distributor having a plurality of pressurised air outlets, one or more of said outlets being in pressurised air communication with one type of pressure cuff selected from a group of possible such cuffs, each pressurised air outlet coupled to its own valve means adapted to open and close the outlets, control means provided to monitor, in use, pressure variation at said outlets and thereby determine which outlets are open and which are closed, and to identify from such determination the particular type of cuff actually connected to the outlet(s).

9. The pressure cuff detection system according to claim 8 wherein the group of cuffs is a group of three, namely a three chamber calf cuff, a one chamber calf cuff and a one chamber foot cuff.

10. The pressure cuff detection system according to claim 8, wherein the system includes a pressure transducer for monitoring pressure between the compressor and the distributor.

11. A pressure cuff detection system according to claim 8, wherein the pressure variation is the pressure rise time.

12. A pressure cuff detection system according to claim 8, wherein the control means is configured to sequentially open each valve means, to monitor the rate of pressure rise and to conclude which type of cuff is attached.

13. A pressure cuff detection system according to claim 8, wherein secondary control means are provided for setting pressure and time cycles for the identified type of cuff.

14. A system as set forth in claim 8, which is a combined cuff type detection and inflation system, wherein detection setup and then inflation cycles can operate sequentially.

15. A system as set forth in claim 14, wherein each valve means comprises an air solenoid.

16. A system as claimed in claim 15, wherein the plurality of pressurised air outlets comprises six pressurised air outlets, the air distributor comprises an air manifold which supplies the six solenoids with an air supply and the control means comprises a pressure transducer fed from the air manifold to monitor the system pressure.

17. A system according to claim 16, wherein the air outlets are connected to a pair of three outlet connectors.

18. A system according to claim 14, wherein the control means comprises a printed circuit board.

19. A method of detecting the presence of a particular type of cuff from amongst a group of possible types of cuff which involves use of a system according to claim 14.

20. A method according to claim 19 comprising sequentially opening each valve means, monitoring the rate of pressure rise and concluding which type of cuff is attached.
